(19) United States
(12) Patent Application Publication
(10) Pub. No.: US 2007/0038504 A1
(43) Pub. Date: Feb. 15, 2007

(54) Method and device for determining the causes of malfunctions and performance limits in installations

(75) Inventors: Stefan Haaks, Erlangen (DE); Gerd Michaelis, Mohrendorf (DE); Chirstian-Marius Weigner, Ansbach (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 10/573,674

(22) PCT Filed: Sep. 24, 2004
(86) PCT No.: PCT/EP04/10746

§ 371 Date: Oct. 25, 2006

(30) Foreign Application Priority Data
Sep. 26, 2003 (DE) 103 45 121.8

(51) Int. Cl. G06Q 99/00; G07G 1/00; H04M 3/51; G06F 17/30; G06F 11/34

(52) U.S. Cl. 705/11; 705/1; 705/10

(57) ABSTRACT

The invention relates to a method and a device for determining the causes of malfunctions and performance limits in installations. It is difficult to determine the causes of disturbances and/or performance-limiting factors in complex installations. The inventive method allows malfunctions in an installation to be eliminated and/or the performance thereof to be increased in a lasting manner and with relatively little effort. Said method comprises the following steps: data is provided on causes of malfunctions and performance limits in a plurality of installations; a questionnaire regarding said causes is created from said data; replies relating to the questions of the questionnaire are solicited from employees working in the installation that is to be diagnosed; and the causes of malfunctions and performance limits of the installation that is to be diagnosed are determined by evaluating the replies supplied by the employees regarding the questions of the questionnaire.

### CROSS REFERENCE TO RELATED APPLICATIONS

This application is the US National Stage of International Application No. PCT/EP2004/010746, filed Sep. 24, 2004 and claims the benefit thereof. The International Application claims the benefits of German Patent application No. 10345121.8 DE filed Sep. 26, 2003. All of the applications are incorporated by reference herein in their entirety.

### FIELD OF THE INVENTION

The invention relates to a method and a device for determining the causes of malfunctions and performance limits in installations.

### BACKGROUND OF THE INVENTION

Technical installations are increasingly complex systems with a plurality of technical devices, which interact with each other. Installations for producing continuous webs, e.g. paper, textiles, plastics or metal films, are characterized by particularly complex combinations of devices for power distribution, drive systems and automation systems, etc.

At the same time many installation operators concentrate increasingly on their core process, i.e. the method-related process, and less on the individual technical components (e.g. drive and automation components), required for the method-related process.

Because of this and as a result of the increasing complexity of the installations, many installation operators find it difficult to determine the causes of malfunctions and performance-limiting factors, i.e. factors that limit the performance of an installation during normal operation, in the case of a paper mill for example the speed of a continuous paper web, in their installations.

Correspondingly many installation operators find it difficult to assess the technical state of their installation so that they can identify potential problems at an early stage or to determine improvement potential so that they can institute improvement measures at an early stage.

Problems in an installation are frequently only identified when the problem manifests itself with a malfunction of the operation of the installation, in the case of a paper production installation for example a tear in the paper web. In some instances such malfunctions can impair the operation of the installation to the point that production stops completely. Many installation operators then try to resolve the problem by appointing and coordinating experts for the sub-area of the installation, in which the problem manifested itself. The experts investigate the relevant sub-area of the installation and generally succeed in eliminating the problems. But the problem is generally not eliminated for long. Problems soon recur in the same or a similar point in the installation.

The same is true of attempts to improve the performance of installations. Many installation operators try to find the performance-limiting factors in their installations themselves. Once they find such a factor in a sub-area of the installation, they appoint experts to carry out improvement measures. For example if the installation operator ascertains that a control valve is not adjusted optimally for example, said operator will appoint a control system specialist to optimize the controller. Unfortunately such measures generally do not last long either. Improvements are only short-term or do not satisfy expectations.

Many solutions and technical assessments are therefore often only partial and are based on the empirical experience of experts in individual sub-areas of an installation. Generally in many installations this means that malfunctions are not eliminated in the long-term, performance improvements are not sustained, improvement potential is not fully exploited and performance-limiting or disruptive factors are not identified early enough.

### SUMMARY OF THE INVENTION

An object of the present invention is therefore to specify a method and a device, which enable early identification of performance-limiting and disruptive factors in an installation and allow long-term malfunction elimination and performance improvement in an installation with relatively little outlay.

This object is achieved by a method and device according to the claims. Advantageous embodiments of the invention are set out in the respective subclaims.

The claimed method is based on the consideration that long-term malfunction elimination or performance improvement is only possible if the functional chains between different technical devices in an installation are identified and taken into account when investigating the causes of malfunctions and performance limits. Determination of the functional chains is made possible in that knowledge about malfunctions or performance limits compiled in a larger number of installations is used when investigating causes. The knowledge compiled in these installations can extend over a plurality of different technical devices in a very wide range of installations, thereby representing a broad pool of knowledge about possible causes of malfunctions or performance limits in an installation under investigation.

To determine the functional chains in an installation it is however necessary to link expert knowledge to the knowledge available internally in the installation. In a next step therefore a questionnaire is generated containing questions about the possible causes. These questions are put to employees involved in the operation and responses to these questions are collected. While until now only a few experts have investigated a few sub-areas of an installation and therefore only the knowledge of a few employees has been included in the investigations, according to the invention the knowledge of a plurality of employees working in the installation in a very wide range of elements of the installation can be included in the investigation of causes. This knowledge can be structured and solicited effectively using the questionnaire, such that the outlay for the method can be minimized. By analyzing the responses of employees to the questions in the questionnaire it is then possible to determine the causes of malfunctions and performance limits in the installation under investigation.

The method therefore provides a standard and systematic procedure. The results that can be achieved can therefore be traced easily, the method can be repeated as required and results obtained in different installations or in the same installation at different times can be compared and used to establish a benchmark. Generally it enables a quasi-objective analysis and assessment of the technical state of an installation, allowing potential and actual causes of malfunctions and performance limits to be determined.

The outlay required for questioning employees can be further reduced by also supplying data about the installation under investigation. It is then possible to select data of relevance to the installation under investigation from the plurality of data about causes of malfunctions and performance limits, thereby generating a questionnaire that only contains questions relating to the installation under investigation.

It is possible to generate the questionnaire, analyze the questions and thus determine the causes of malfunctions and performance limits particularly quickly and accurately since
the data about the causes of malfunctions and performance limits is stored in a first database,
the data about the installation under investigation is stored in a second database,
the questionnaire is generated from the data in the first and second databases by a data processing unit and output by an output unit,
the responses of the employees are captured via an input unit and stored in the second database,
the causes of malfunctions and performance limits are determined by the data processing unit based on the stored responses of the employees.

A claimed device for fast and accurate generation of the questionnaire and assessment of the questions therefore has the following components:
a first database containing data about causes of malfunctions and performance limits in a plurality of installations,
a second database containing data about the installation under investigation,
an output mechanism to output a questionnaire about these causes from this data,
an input mechanism to input responses of employees working in the installation to the questions in the questionnaire,
a data processing unit to generate the questionnaire from the data in the first database and the second database and to determine the causes of malfunctions and/or performance limits by analyzing the responses of the employees to the questions in the questionnaire.

A central element of the device is the first database containing data about causes of malfunctions and performance limits that are generally possible in installations. This data can be compiled over a plurality of installations and the technical devices contained therein and can therefore represent a broad knowledge base for the assessment of the technical state of a specific installation. A second database contains data about the installation under investigation and thus allows this data to be compared with the data stored in the first database, thereby capturing the data from the first database, which is of relevance to the specific installation under investigation. A data processing unit is used to generate the questionnaire about possible technical problems in the installation to be assessed from the data in the first database and the data in the second database, said questionnaire being output via an output mechanism.

The first database can hereby be permanently installed at a central point, e.g. on the premises of a technical service provider, while the second database, the data processing unit and the input and output units are movable and are located on site in the installation under investigation. This means that the first database containing the general cause data can be administered, extended and updated at a central point, while the questionnaire can be generated and output on site in the installation. The data processing unit can access the data in the first database on site in the installation via a data communication connection to the first database.

The first database can however also be movable, together with the second database, the data processing unit and the input and output units and can for example be located on site in the installation under investigation.

Generally the two databases do not have to be two physically separate data storage units. Instead they can be two different storage areas in a physically shared data storage unit (shared memory). The data processing unit, the second database, optionally the first database and the input and output units can be integral parts of a single mobile computer unit.

### BRIEF DESCRIPTION OF THE DRAWINGS

The invention and further advantageous embodiments of the invention according to the features of the subclaims are described in more detail below with reference to exemplary embodiments in the figures, in which:

FIG. 1 shows a simplified diagram of a paper production installation,

FIG. 2 shows a claimed device for determining the causes of malfunctions and performance limits in an installation,

FIG. 3 shows an example of the data stored in the first and second databases of the device according to FIG. 2 and the generation of a questionnaire,

FIG. 4 shows a system for supplying and updating the data contained in the first database.

### DETAILED DESCRIPTION OF THE INVENTION

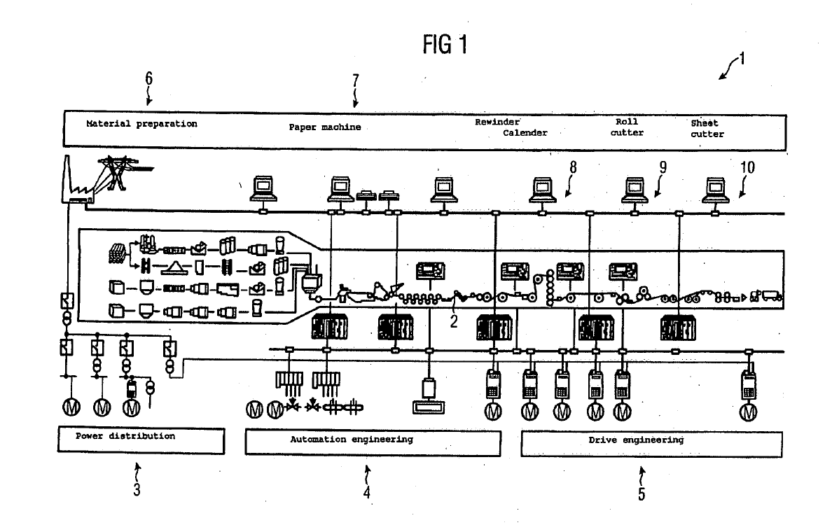

FIG. 1 shows a simplified diagram of an installation 1 for producing a continuous paper web 2. The unit 1 comprises the installation elements material preparation 6, paper machine 7, rewinder/calender 8, roll cutter 9 and sheet cutter 10. All these installation elements include components for power distribution 3, automation engineering 4 and drive engineering 5. Overall the installation 1 is therefore a complex system comprising an extremely diverse range of very different, interacting, technical devices. The complex interactions of the various installation elements and devices means that functional chains between the various installation elements are difficult to find, it is difficult for an installation operator to determine malfunctions and performance limits and the technical state of the installation is difficult to assess.

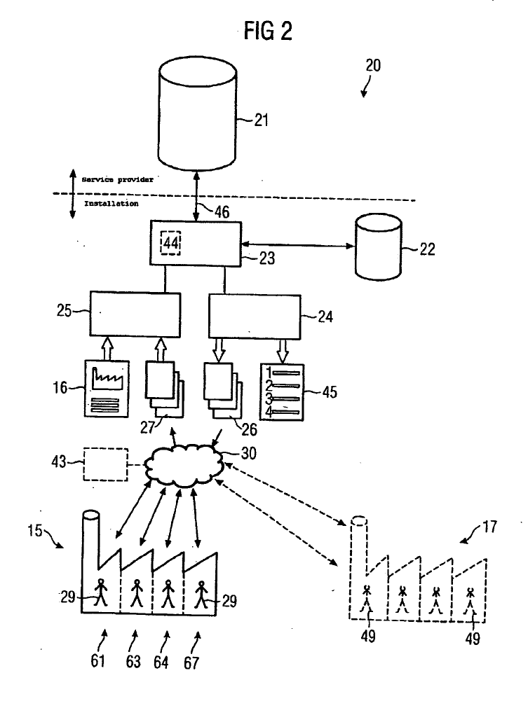

FIG. 2 shows a claimed device 20 for determining causes of malfunctions and performance limits in an installation 15. The installation has the installation elements 61, 63, 64 and 67, the people employed in the installation are shown as 29. The device 20 contains a first database 21 containing data about causes of malfunctions and performance limits that are generally possible in installations. It therefore represents a comprehensive pool of knowledge about problems, which have already occurred in other installations and could potentially also occur in the installation under investigation 15.

A second database 22 contains data about the installation under investigation 15. This data is requested beforehand by the operator of the installation 15, for example by means of a questionnaire 16, and stored via an input unit 25 and a data processing unit 23 in the second database 22.

The data processing unit 23 is used to generate a questionnaire about possible causes of malfunctions and performance limits in the installation under investigation from the data in the first database 21 and the second database 22. This questionnaire 26 is output via the output mechanism 24 in paper form or electronic form.

The employees 29 working in the installation 15 are preferably questioned in personal interviews between the people responsible for the investigation and the employees 29, as employees 29 are more likely to disclose sensitive information in particular in personal discussions. Alternatively the employees 29 can also be questioned via a data network 30. To this end the output unit 26 and the input unit can advantageously be connected to the employees 29 via a data communication network 30 (e.g. an intranet). The questions can then be transmitted to the employees in the form of emails for example or questions can be answered via a web server 43. This is particularly advantageous when a large number of employees have to be questioned in a short time.

The responses 27 of the employees 29 to the questions are input via the input mechanism 25 into the device 20 and stored in the second database 22. The data processing unit 23 then uses the responses 27 of the employees 29 to the questions in the questionnaire 26 and an assessment rule 44 stored in the data processing unit 23 to determine the causes of malfunctions and/or performance limits in the installation 15. The assessment results 45 determined by the data processing unit 23 are output via the output unit 24.

According to a particularly advantageous embodiment of the invention, the device 20 is provided and serviced by a technical service provider. The employees are also preferably questioned by a technical service provider.

The database 21 can be installed in a fixed location, e.g. in the headquarters of the service provider, while the second database 22, the data processing unit 23, the output unit 24 and the input unit 25 are located locally on site in the installation under investigation 25. The data processing unit 23 then exchanges data with the database 21 via a bidirectional communication connection 46. The entire device 20 can however also be configured as a mobile unit. The data processing unit 23, the output unit 24 and the input unit 25 can thus be parts of a mobile computer system, with the databases 21 and 22 being stored in the storage unit of the mobile computer system.

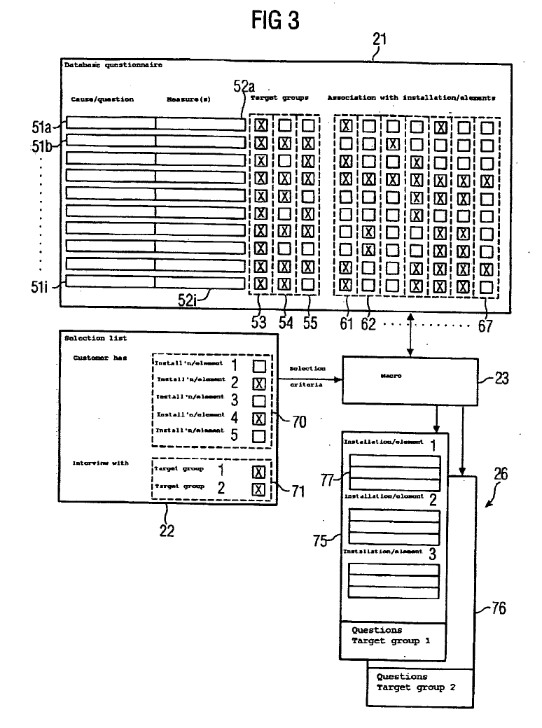

FIG. 3 shows a particularly advantageous exemplary embodiment of the data stored in the first (21) and second (22) databases of the device 20 according to FIG. 2 and the generation of the questionnaire 26. Data 51a to 51i about the causes of malfunctions or performance limits that are generally possible in installations is stored in the first database 21. The causes can hereby also be stored in the form of questions about the causes.

One or more improvement measures 52a-i are preferably assigned respectively to the data 51a-i. The measure 52a is thus assigned to the question 51a, the measure 52b to the question 51b, etc. If during the analysis of the responses a specific cause is identified for a malfunction or performance limit, the device 20 can automatically propose an improvement measure.

The data 51a-i about the causes is advantageously assigned respectively to target groups 53, 54, 55. The data about the installation under investigation 15 contains details of the target groups to be questioned and the questionnaire 26 is generated such that it only contains questions for employees 29 in the target groups to be questioned. In the example in FIG. 3 three target groups 53, 54, 55 are defined in the first database 21. The question 5la is only assigned to the target group 53. The question 5lb is assigned to the target groups 53, 54 and 55, etc. Data 71 about the target groups to be questioned is contained in the second database 22.

By assigning the questions/causes to target groups, it is possible to tailor the questionnaire selectively to target groups in the installation under investigation, with a target group only receiving questions relevant to it. Questioning can therefore take place quickly and with the minimum outlay.

The data 52a-i about the questions/causes is assigned respectively to installation elements 61-67 in a correspondingly advantageous manner. The data in the second database 22 contains details 70 about installation elements occurring in the installation under investigation 15 and the questionnaire 26 is generated such that it only contains questions for installation elements occurring in the installation 15. In the example in FIG. 3 six installation elements 61-67 are defined in the second database 22. The question 51a is assigned to the installation element 61 and 65, the question 51b to the installation element 63, etc. The installation elements 71 of relevance to the installation 15 are defined in the second database 22.

By assigning questions/causes to installation elements, it is possible to tailor the questionnaire selectively to the installation elements, i.e. it only contains questions for installation elements that occur in the installation 15. Questioning can therefore take place quickly and with the minimum outlay and the accuracy of the investigations is improved. The analysis of the responses is also simplified and functional chains can be identified more easily between different installation elements.

The installation operator is preferably provided with a selection list of the target groups 53, 54, 55 and installation elements 61-67 defined in the database 21 and said operator's selection is preferably stored in the second database 22 as data 70, 71.

The questionnaire 26 generated by the data processing unit 23 is preferably sorted by target groups according to FIG. 3. Sorting by installation elements then takes place within the target groups. Employees can then be questioned particularly quickly and with minimum outlay.

By analyzing the responses of the employees, it is possible to obtain the actual and potential causes of malfunctions and performance limits. The analysis can for example be based on the frequency of the same responses from employees to a specific question or major difference in the responses within one or more target groups. Important knowledge can also be obtained by comparing the responses of different target groups and different installation elements.

According to an advantageous embodiment of the invention, the analysis is only carried out in respect of installation elements, i.e. over a number of questions relating to a specific installation element.

The technical state of the installation can advantageously be assessed using the responses and with the aid of an assessment rule.

If the employees questioned are unable to provide responses to a lot of questions, if the responses of different groups to the same question differ significantly and if only a few improvement measures have been implemented and deployed, only a relatively poor assessment rating is possible.

If the employees questioned are unable to provide responses to some questions, if the responses of different groups to the same question only differed slightly and if improvement measures have been implemented and deployed, an average assessment rating is possible.

A very good assessment rating is for example possible, if the responses were given definitively and pretty spontaneously by the employees, responses from different groups to the same question are the same and the results of all previous improvement measures have been documented and were successful.

Improvement measures can also be proposed by the device 20 for the installation elements with a low number of assessments. The device 20 can automatically propose the associated measures for questions which were not answered by employees. These measures can be prioritized according to a weighting stored in the first database 21. The weighting can in particular be stored in the first database in a sector-specific manner.

According to a particularly advantageous embodiment of the invention, the questions in the questionnaire 26 relate to drive and/or automation components of the installation. Drives in particular are central elements of many installations and major factors in determining the reliability, output and quality of the installations.

Possible examples of questions relating to the drive system and improvement measures that can be proposed are:
Do you have enough spare parts for the system on site? If not, how reliable is your supply of spare parts?
Do you check the capacitors of your replacement power converter regularly? If not, set up a maintenance procedure.
Do you have the current version of your hardware/software documentation? If not, a review should be carried out.

Further questions and improvement measures that can be proposed may relate to the operation of the installation:
Does your system provide all the necessary relevant values? If not, could it be modernized or would a data acquisition or monitoring system help?
Does the machine operate in a stable manner at all speeds and with all products? If not, the system structure should be checked.
Does the system respond as expected, when you change settings? If not, the setting and regulating structure could be defective.

Further questions and improvement measures may relate to regulation and control or load distribution:
Are your drive parameters changed from time to time? If so, why? Is the regulation system correct? Or is there unusual wear?
   In the case of a paper production installation, further questions and improvement measures may relate to the roll cutter, for example.
   A poor assessment rating for an installation element can mean that there are weak points in these installation elements. These have not yet been determined and taken into account. There is therefore significant potential for improvement. These improvement options are known to the employees in these installation elements.

An average assessment rating shows for example that there are not very many weak points that have not yet been dealt with in the installation. There is however potential for improvement in some areas. The improvement options are not known to the employees in these installation elements.

A very good assessment rating shows that improvement measures have already been instituted. All those involved are well informed and support these measures. There is a continuous search for new potential for improvement and such potential is consequently achieved. There are almost no critical areas and little potential for improvement.

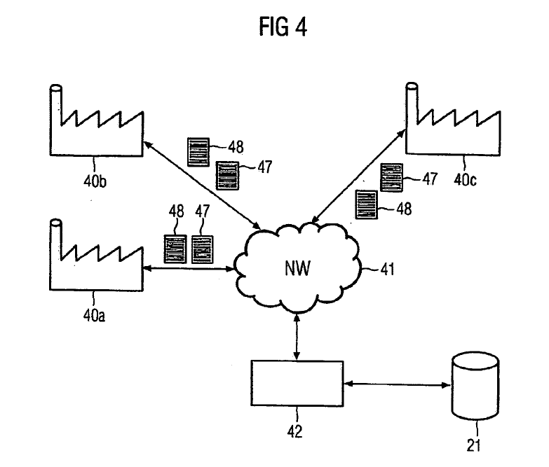

The data (51a-i) about causes of malfunctions and performance limits can—as shown in FIG. 4—be supplied in a simple manner by obtaining the data from malfunction reports 47 and/or field reports 28 from other installations 40a, 40b, 40c. The malfunction reports are for example installation-internal reports by maintenance and repair operators about malfunctions that have occurred and their causes and measures to eliminate the malfunctions. The field reports 48 can also contain information about investigations relating to performance-limiting factors and associated improvement measures. The database 21 is connected for this purpose via a data processing unit 42 and a data communication network 41 (e.g. the internet) to the installations 40a-c and receives the malfunction reports 47 and field reports 48 from the installations 40a-c. The malfunction reports 47 and field reports 48 can be used to supplement or update the data contained in the database 21.

1-18. (canceled)

19. A method for determining causes of disruptive factors in an installation under investigation, comprising:
gathering relevant causation data of performance limits for a plurality of related installations;
generating a questionnaire from the causation data wherein the questionnaire only contains questions relating to the installation under investigation;
collecting responses to the questionnaire questions from employees of the installation under investigation;
analyzing the employee responses to the questionnaire; and
determining the causes of disruptive factors of the installation based on the questionnaire analysis.

20. The device as claimed in claim 19, wherein the disruptive factors are selected from the group consisting of malfunctions and performance limits.

21. The method as claimed in claim 20, further comprising:
storing the causation data in a first database,
storing the installation under investigation data in a second database,
generating the questionnaire by a data processing unit that uses data in the first and second databases,
outputting the questionnaire by an output unit,
collecting the employee responses via an input unit,
storing the employee responses in the second database, and
determining the causes of malfunctions and performance limits by the data processing unit based on the stored responses of the employees.

22. The method as claimed in claim 21, wherein improvement measure data is stored in the first database.

23. The method as claimed in claim 22, further comprises:
assigning the relevant causation data to an installation element, wherein the data in the second database contains data about installation elements occurring in the installation under investigation, and
the questionnaire contains questions for installation elements occurring within the installation.

24. The method as claimed in claim 23, further comprises:
assigning the causation data to target groups of the installation,
generating the questionnaire such that the questionnaire contains questions for employees in the target groups to be questioned, wherein the installation under investigation data contains details about the target groups to be questioned.

25. The method as claimed in claim 24, wherein the questionnaire is directed to drive or automation components of the installation.

26. The method as claimed in claim 25, wherein the responses of the employees are collected via interviews.

27. The method as claimed in claim 26, wherein the responses of the employees are collected via a data network.

28. The method as claimed in claim 27, wherein the relevant causation data is obtained from malfunction or field reports from other installations.

29. The method as claimed in claim 28, wherein the method is implemented by a technical service provider.

30. The method as claimed in claim 29, wherein an assessment of the technical state of the installation is made based on the responses of the employees and with a defined assessment rule.

31. The method as claimed in claim 30, wherein the questionnaire only contains questions for installation elements occurring in the installation and the questionnaire is generated such that it only contains questions for employees in the target groups to be questioned.

32. A device for determining the causes of disruptive factors in an installation, comprising:
a first database that contains data about causes of malfunctions in a plurality of installations and improvement measure data;
a second database that contains data about the installation under investigation;
an output mechanism to output a questionnaire;
an input mechanism to input responses of employees working in the installation to the questions in the questionnaire and to input the data about the installation under investigation; and
a data processing unit to generate the questionnaire from the data in the first database and the second database and to determine the causes of disruptive factors of the installation under investigation by analyzing the responses of the employees to the questions in the questionnaire wherein:
causation data is assigned to target groups of the installation and installation elements,
data about the installation to be assessed contains data about the target groups to be questioned,
the questionnaire being generated such that it contains questions for employees in the target groups to be questioned.

33. The device as claimed in claim 32, wherein the disruptive factors are selected from the group consisting of malfunctions and performance limits.

34. The device as claimed in claim 33, wherein the first data base further contains data about causes of performance limits.

35. The device as claimed in claim 34, further wherein:
the data in the second database contains details about the installation elements in the installation under investigation, and
the questionnaire contains questions for installation elements occurring in the installation.

36. The device as claimed in claim 35, wherein the output unit and the input unit are connected to a data communication network that is accessible by the employees.

37. The device as claimed in claim 36, wherein the first database is connected to a plurality of installations via a data network.

38. The device as claimed in claim 37, wherein the questionnaire being generated only contains questions for employees in the target groups to be questioned.
